(19) United States
(12) Patent Application Publication
(10) Pub. No.: US 2015/0061341 A1
(43) Pub. Date: Mar. 5, 2015

(54) VEHICLE-HEADREST SUPPORT

(71) Applicants: Stefan S. GRAF, Nabburg (DE); Johannes RAAB, Wackersdorf (DE)

(72) Inventors: Stefan S. GRAF, Nabburg (DE); Johannes RAAB, Wackersdorf (DE)

(21) Appl. No.: 14/469,883

(22) Filed: Aug. 27, 2014

(30) Foreign Application Priority Data
Aug. 28, 2013 (DE) 102013014222.9

(51) Int. Cl. B60N 2/48

(52) U.S. Cl. CPC B60N 2/4852
USPC 297/408

(57) ABSTRACT

The invention relates to a mount assembly comprising a frame (A) for mounting at least one headrest support rod (13a, 13b) and formed with at least one locating seat (29) for locating and mounting the support rod (13a, 13b) and an escutcheon (19) that can be fixed to the frame (A) and that has a first centering formation (23) that acts in conjunction with second centering formation (42) of the device (10) in order to center a central axis m₁ of a guide passage (43) formed in the escutcheon (19) with a central axis m₂ of the locating seat (29).

The special feature is that the escutcheon (19) has a first positioning formation (35) that acts in conjunction with a second positioning formation (30) of the mount assembly in order to define an angular position of the escutcheon (19) about the central is axis m₁ relative to the frame (A).

The invention relates to a mount assembly for mounting a headrest.

The headrest has a head contact part mounted on a vehicle seat by at least one support rod. The head contact part can, for example, comprise one support rod or two individual support rods or a support bracket with two support rod ends. Each support rod is retained in a guide tube of at least one frame of the mount assembly. The mount assembly is fixed to the structure of the vehicle seat. In particular, the mount assembly is fixed to the backrest of the vehicle seat. The guide tube forms at least one locating seat for locating and mounting the support rod. The support rod is movable in the locating seat and can be locked, for example in at least one position.

The vehicle seat is provided with a cushion. The support rods passes through a hole of the cushion. When the support rod is fitted in the mount assembly, the support rod is fed through the hole of the cushion and pushed into the locating seat. An escutcheon can be fixed to the guide tube in order to guide the support rod through the hole in the cushion to the locating seat, and in order to visually cover the hole in the cushion.

The escutcheon forms a guide passage through which the support rod is guided to the locating seat of the guide tube. The escutcheon also has a first centering formation that acts in conjunction with a second centering formation of the frame in order to center a central axis m₁ of the guide passage formed in the escutcheon with a central axis m₂ of the locating seat of the guide tube.

It is often difficult to install the escutcheon, as the mount assembly cannot be seen through the hole in the cushion.

It is an object of the invention to create a headrest mount assembly in which the escutcheon is easy to fit.

The object is achieved by a headrest mount assembly with the characteristics of claim 1.

The escutcheon has at least one first positioning formation that acts in conjunction with at least one second positioning formation of the mount assembly. The first and the second positioning formations can act together in such a way, for example, that the escutcheon can only move into its seat and, if appropriate, be locked therein, when the first and the second positioning formation are engaged with each other.

The first centering formation is a plug-in projection, for example, that can be brought into engagement with a plug-in seat of the second centering formation. The plug-in projection is complementary to the plug-in seat for example.

The plug-in projection is formed coaxially, for example, with respect to a central axis of the guide passage. The plug-in projection is cylindrical, for example, in particular in the form of a cylindrical tube. The plug-in projection can be provided, for example, in the plug-in direction with a frustoconical outer wall, as a result of which it can be moved more easily into the complementary seat in the mount assembly.

The escutcheon has a stop, for example that limits the plug-in depth of the plug-in projection. The stop is formed, for example, as an annular ridge. It has a stop face that can be moved into contact with a mating face of the mount assembly.

According to an embodiment, the plug-in projection projects forward in the plug-in direction relative to the stop. In this way, during assembly, the plug-in projection comes into contact first with the plug-in seat of the mount assembly and centers the guide passage of the escutcheon with the locating seat of the mount assembly.

The first and second positioning formation are, for example, formed offset from the central axis. The first and second positioning formation are, for example, formed in such a way that they can only be fitted together in a certain relative angular position of the escutcheon relative to the mount assembly. When the first and second centering formations have been moved into engagement and the installer has also moved the first and second positioning formation into engagement by rotating them, the escutcheon can, for example, be moved in the plug-in direction until the stop comes into contact with a face of the mount assembly. This tells the fitter that the escutcheon is properly seated.

Since the first and second positioning formation are formed offset from the central axis of the escutcheon and of the locating seat, when they are engaged the positioning formations form a latch that prevents rotation of the escutcheon about its central axis.

The first positioning formation is a pin, for example that can be brought into engagement with the second positioning formation that is formed by a complementary recess.

The first and the second positioning formation are provided at the stop, for example. They can be formed on the stop, for example.

According to one embodiment, the mount assembly has a latch formed by a first latch formation of the escutcheon and a second latch formation of the mount assembly. The first and second latch formations can, for example, be formed by interacting latching elements.

According to a second aspect of the invention, the invention relates to a headrest device with a headrest mounted on the backrest of a vehicle seat by at least one support rod.

It was an object of the invention to create a headrest is device that is easy to assemble.

The object is achieved by a headrest device with the characteristics of claim 12.

The headrest device has a mount assembly according to the first aspect of the invention.

With regard to the advantages and characteristics, reference is made to the comments relating to the first aspect of the invention.

Further advantages can be seen with reference to an illustrated embodiment shown schematically in the figure. In the drawing:

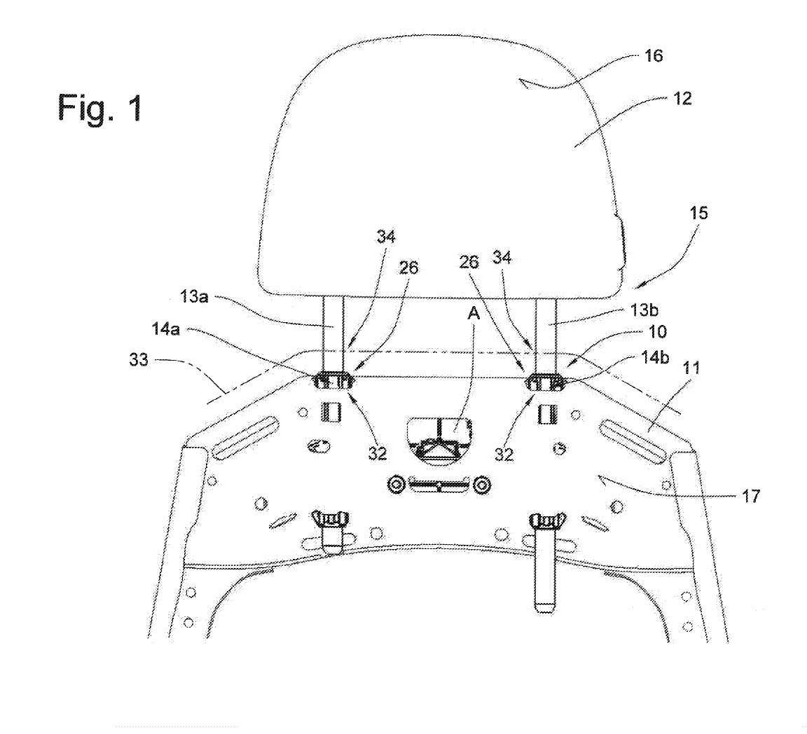

FIG. 1 is a front view of a vehicle seat with a headrest mount assembly fixed to the vehicle seat,

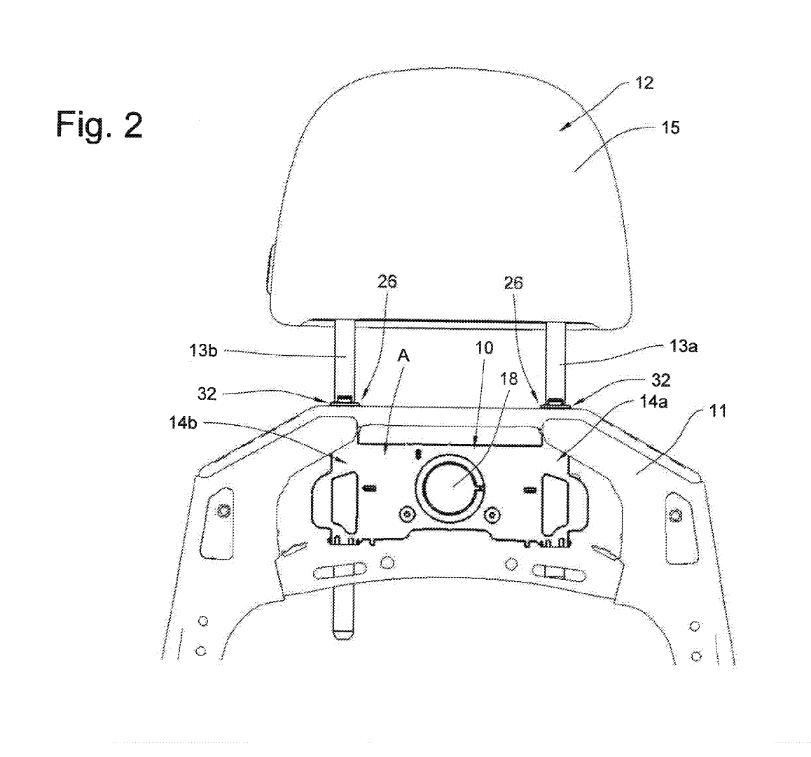

FIG. 2 is a rear view of the vehicle seat according to FIG. 1,

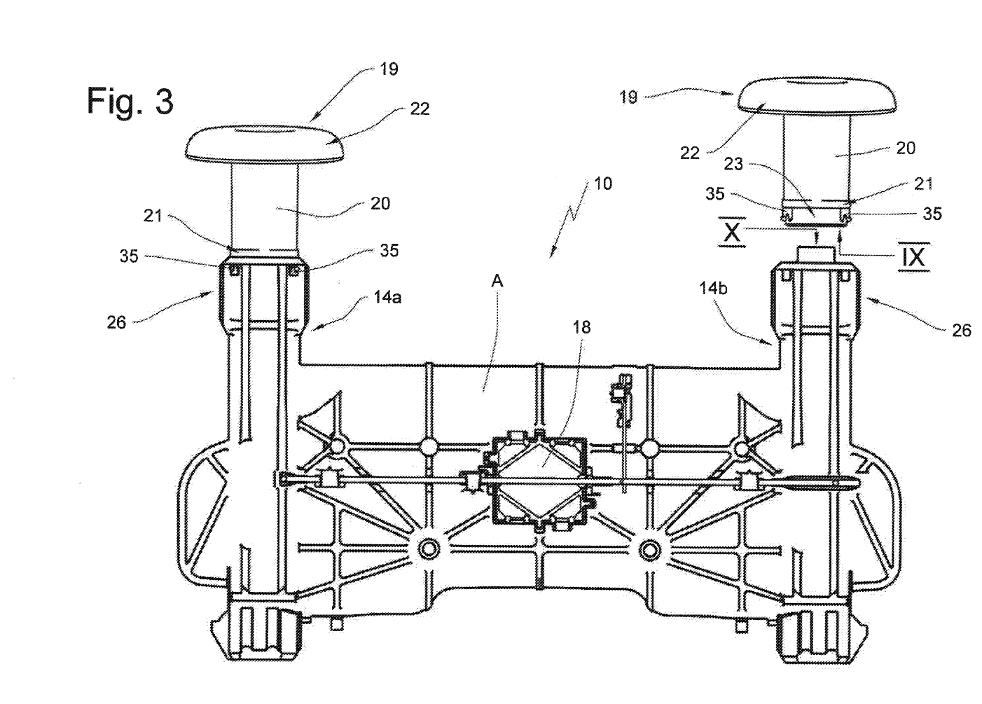

FIG. 3 is a front view of the mount assembly according to FIG. 1. the vehicle seat and the headrest not being shown,

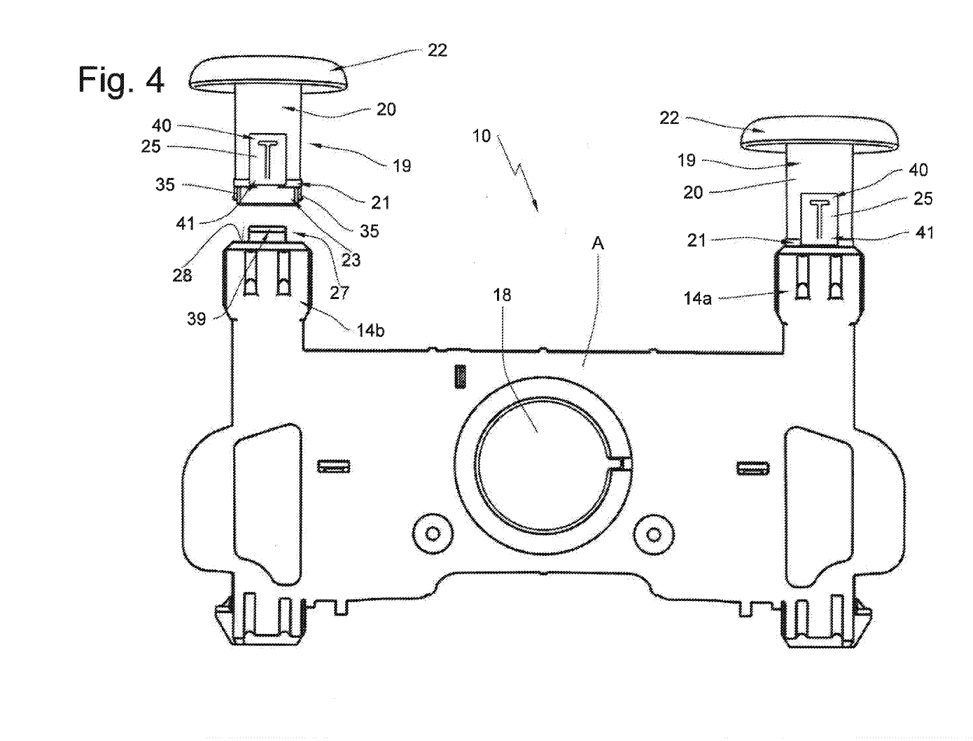

FIG. 4 is a rear view of the mount assembly according to FIG. 3,

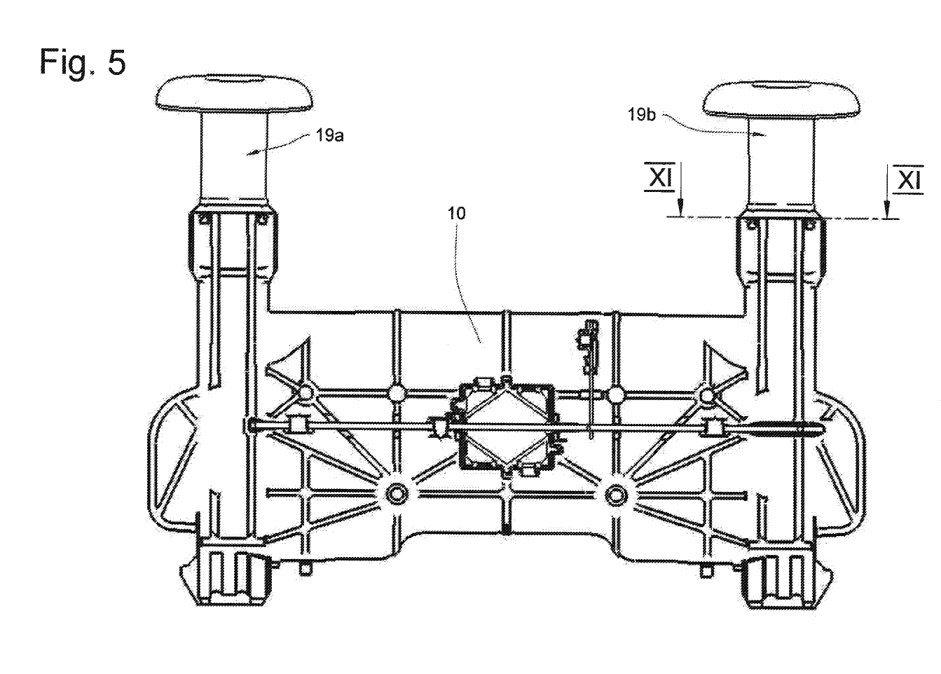

FIG. 5 shows the mount assembly according to FIG. 3, with the escutcheons installed,

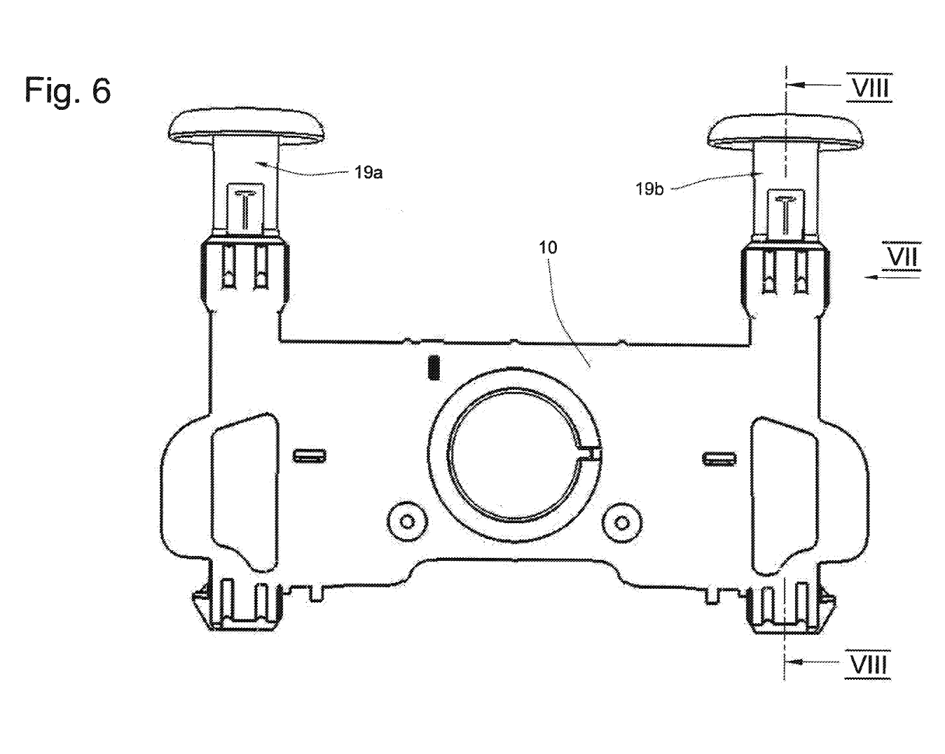

FIG. 6 shows the mount assembly as in FIG. 4 with the escutcheons installed,

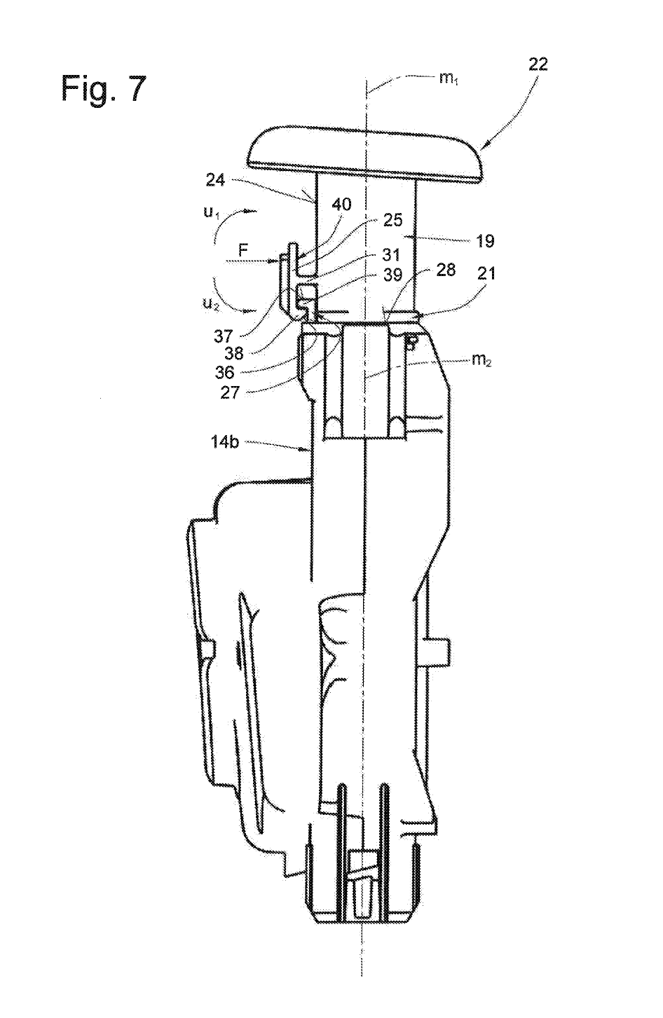

FIG. 7 is a view in the direction of arrow VII in FIG. 6,

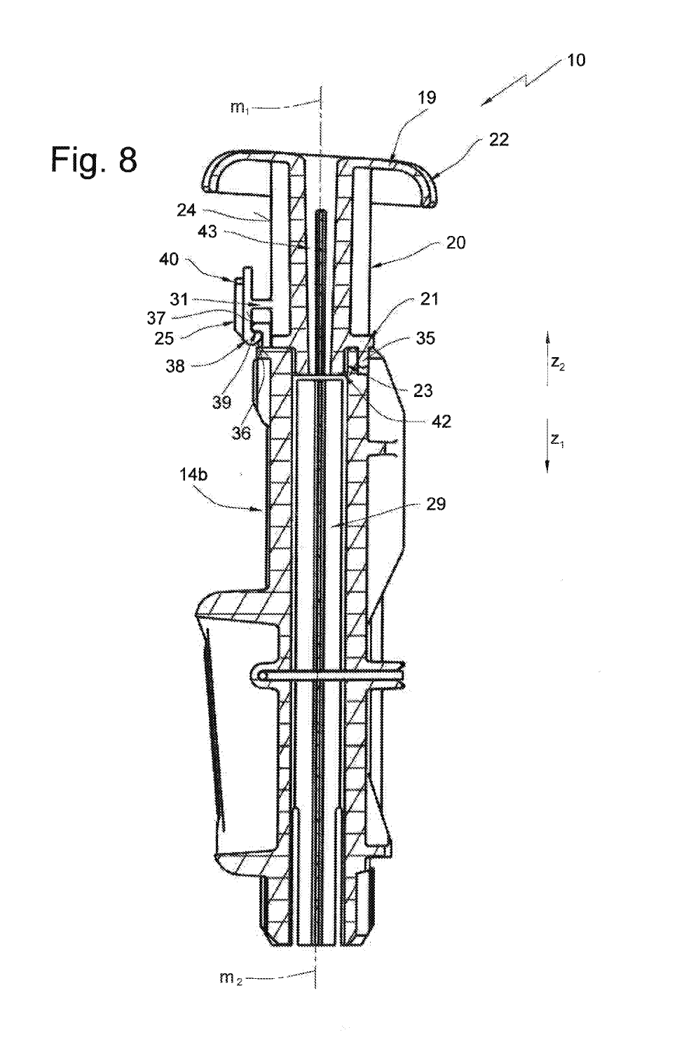

FIG. 8 is a section taken along line VIII-VIII in FIG. 6,

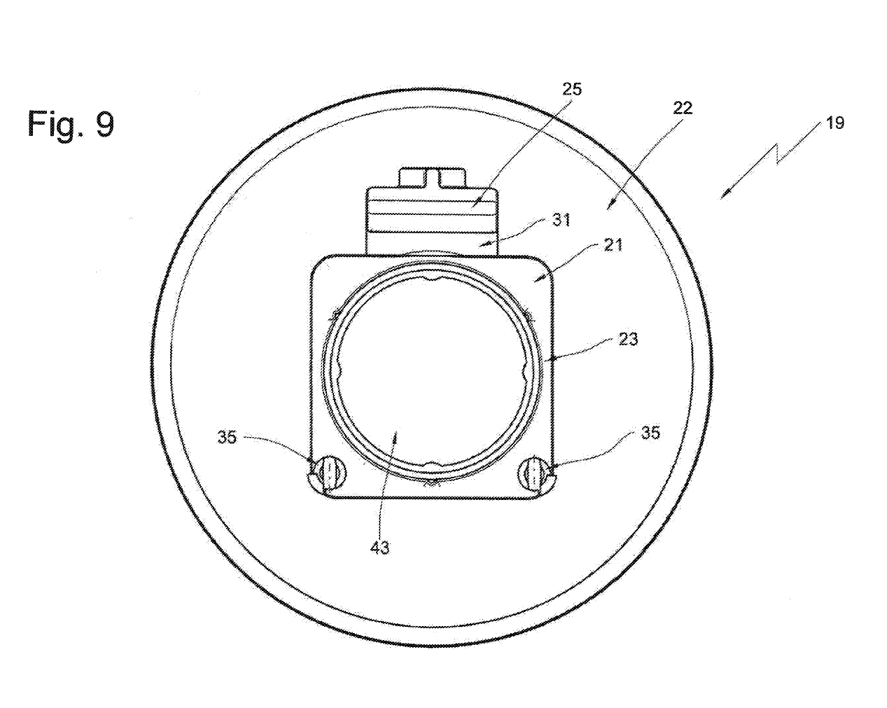

FIG. 9 is a view in the direction of arrow IX of FIG. 3,

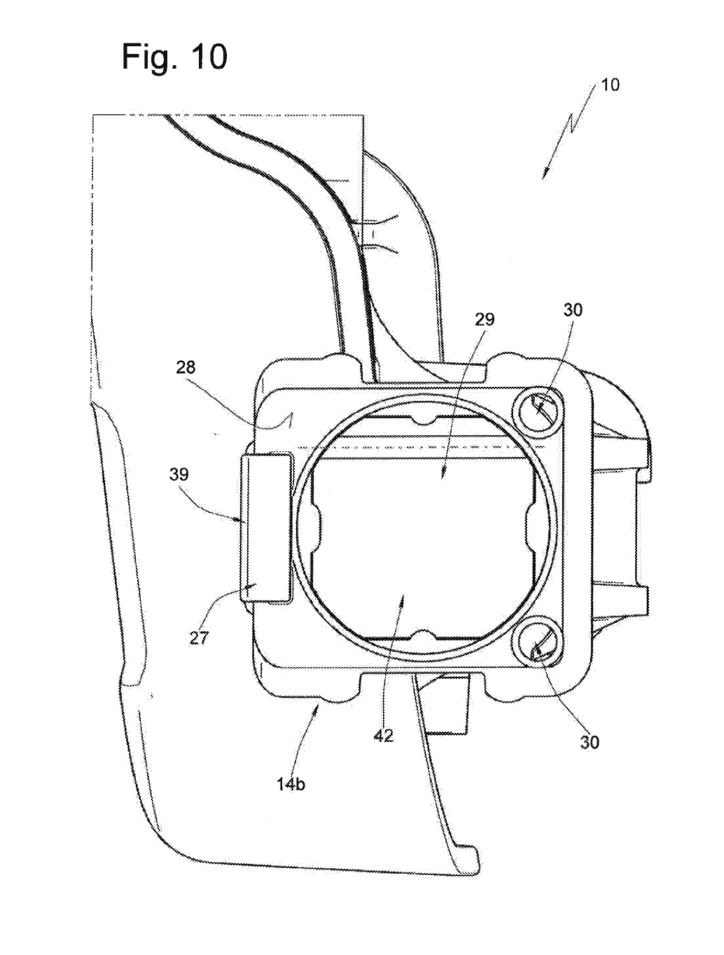

FIG. 10 is a view in the direction of arrow X FIG. 3,

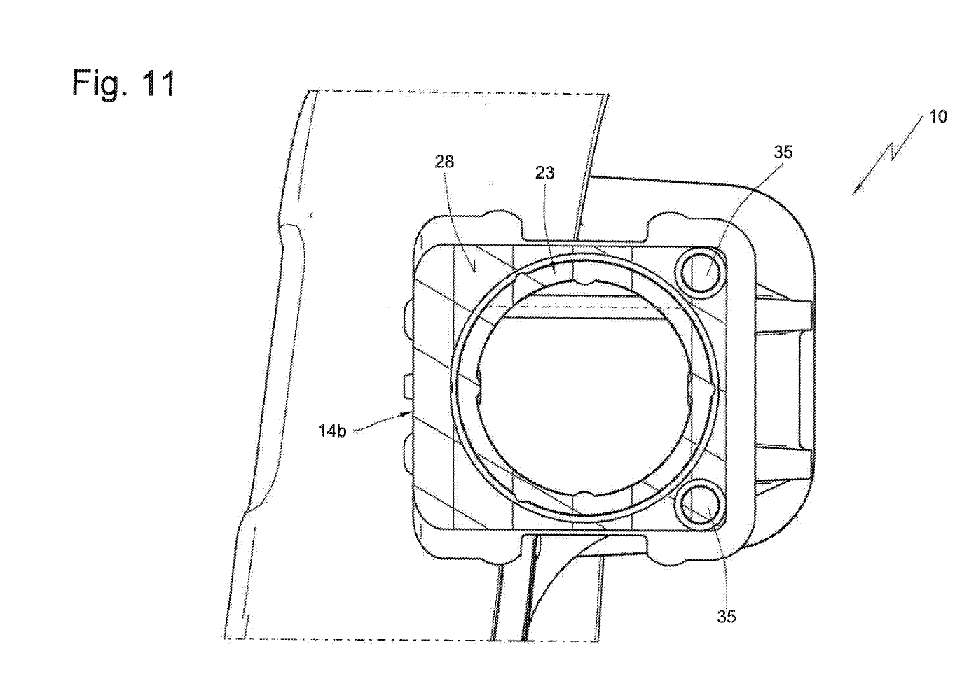

FIG. 11 is a section taken along line XI-XI in FIG. 5.

The same references in the different figures designate the same parts, even when lowercase letters are added or omitted.

A vehicle seat 11 with a headrest 12 is shown in FIG. 1. The vehicle seat 11 has a backrest provided with a face 17 for supporting the occupant of the seat. The headrest 12 has a head contact part 15 with a head face 16 and support rods 13a and 13b, the support rod 13a being mounted in a guide tube 14a and the support rod 13b in a guide tube 14b of a mount assembly 10. Each guide tube 14a and 14b has a locating seat 29. The support rods 13a and 13b can be retained in the mount assembly 10 in a lockable and releasable manner by a latch. The guide tubes 14a and 14b are securely connected to a frame A fixed to the vehicle seat 11.

FIG. 2 is a rear view of the vehicle seat 11 and the mount assembly 10. A button 18 is provided for unlocking the latch when the headrest is to be removed from the guide tubes 14a and 14b of the mount assembly 10.

For clarity of view, upholster 33 of the vehicle seat 11 is only shown by a dashed line in FIGS. 1 and 2 in purely schematic form. The mount assembly 10 has escutcheons 19 that can be fixed to the frame A. The support rods 13a and 13b are surrounded in the cushion 33 by the escutcheons 19. In addition, the holes for the support rods 13a and 13b in the cushion 33 is covered by the escutcheons 19. The covering has the purpose of reducing a risk of injury and to provide the user with a finished high-quality appearance.

According to FIGS. 7, 8 and 9, each escutcheon 19 has a cylindrical tube 20 with an annular stop 21, a bezel 22 in the form of an annular collar, and a plug-in end 23. The bezel 22 overlaps the edge of the hole 34 in the cushion 33 and rests on an outer surface of the cushion 33. The plug-in end 23, formed coaxially around a central axis m₁ of the guide passage 43 of the escutcheon 19, sits in a seat 42 at the upper end of the locating seat 29 of the guide tube 14[a or 14b]. The annular stop 21 rests on the end face 28.

The tube 20 forms a guide passage 43 with a central axis m₁ extending through the escutcheon 19. When the plug-in end 23 fits in the seat 42, the central axes m₁ and m₂ of the guide passage and locating seat are coaxial.

Each escutcheon 19 has two locator pins 35 that are formed on the annular stop 21 and project in a plug-in direction z₁ from the annular stop 21. The locator pins 35 engage in recesses 30 of the respective guide tubes 14a and 14b.

A first catch 25 that engages releasably with a second catch 27 in order to fix the escutcheon 19 to a top end 26 of the respective guide tube 14a or 14b, is formed on an outer surface 24 of the tube 20. The first catch 25 and the second catch 27 are part of another latch.

The first catch 25 has a hook 38 supported on the tube 20 by an elastically deformable web 31. The hook 38 has end 40 and 41. The web 31 is designed to be elastically deformable so that the first catch 25 can be pivoted in directions u₁ and u₂.

The second catch 27 are fixed to the end faces 28 of the guide tubes 14a and 14b. It has a ridge 39 under which the hook 38 can engage.

The mount assembly is fitted to the vehicle seat as follows. First, the frame A is fixed to the vehicle seat 11. When the mount assembly 10 of FIGS. 3 and 4 is installed, the end faces 26 of the guide tubes 14a and 14b project out of holes 32 of the seat structure of the vehicle seat 11. The vehicle seat 11 is then fitted with the cushion 33. The cushion 33 has the holes 34 at the position of the guide tubes 14a and 14b.

The escutcheons 19 can then be fed through the holes 34 and fitted to the guide tubes 14a and 14b. For this purpose, the plug-in end 23 is pushed into the seat 42 in a direction z₁ so that the central axis m₁ of the guide passage 43 is coaxial with a central axis m₂ of the locating seat 29. The escutcheon 19 is then rotated about the central axis m₁ until the locator pins 35 are aligned the recesses 30. The escutcheon 19 can then be moved further in the direction z₁.

When the escutcheon 19 is moved in the direction z₁, an angled surface 36 of the first catch that is inclined relative to the direction of movement z₁ comes into contact with a face 37 of the second catch, thereby pivoting the first catch 25 in the direction u₁. As soon as the hook 38 of the first catch 25 has passed a radially projecting ridge 39 of the second catch 27, the first catch 25 pivots back by its elastic restoring force in the direction u₂, and the hook 38 engages beneath the ridge 39 in an interlocking manner (see FIGS. 7 and 8). The escutcheon 19 is thereby fixed to the respective guide tube 14a and 14b.

The escutcheon 19 can be released from the guide tube 14a by exerting a force F on the upper end 40 of the first catch 25. The first catch 25 then pivots in the direction u₁ and the engagement of the projection 38 with the ridge 39 is released. Thereupon, the escutcheon 19 can be removed in a direction z₂.

1. A mount assembly comprising at least one headrest support rod;
a frame for mounting the support rod and formed with at least one locating seat for locating and mounting the support rod;
an escutcheon that can be fixed to the frame and that has a first centering formation that acts in conjunction with a second centering formation of the frame in order to center a central axis m₁ of a guide passage formed in the escutcheon with a central axis m₂ of the locating seat; and
a first positioning formation on the escutcheon that acts in conjunction with a second positioning formation of the mount assembly in order to define an angular position of the escutcheon about the central axis m₁ relative to the frame.

2. The mount assembly as claimed in claim 1, wherein the escutcheon has a stop.

3. The mount assembly as claimed in claim 1, wherein the first centering formation is a plug-in projection.

4. The mount assembly as claimed in claim 1, wherein the second centering formation includes a seat for the plug-in projection.

5. The mount assembly as claimed in claim 4, wherein the plug-in projection is formed coaxially with respect to a central axis m₁ of the guide passage.

6. The mount assembly as claimed in claim 4, wherein the plug-in projection is cylindrical.

7. The mount assembly as claimed in claim 4, wherein the plug-in projection projects in a plug-in direction from the stop.

8. The mount assembly as claimed in claim 1, wherein the first positioning formation is offset from the central axis of the guide passage.

9. The mount assembly as claimed in claim 1, wherein the first positioning formation is a pin.

10. The mount assembly as claimed in claim 1, wherein the first positioning formation projects in a plug-in direction relative to the stop.

11. The mount assembly as claimed in claim 1, wherein the escutcheon can be fixed to the frame by a latch formed by a first latch formation of the escutcheon and a second latch formation of the frame.

12. A headrest assembly with a headrest mounted on a vehicle seat by at least one support rod, with a mount assembly for mounting the headrest as claimed in claim 1.
